(19) United States
(12) Patent Application Publication
(10) Pub. No.: US 2025/0016482 A1
(43) Pub. Date: Jan. 9, 2025

(54) NETWORK INTERFACE DEVICE AND IMPROVED ROUTING DEVICE

(71) Applicant: CenturyLink Intellectual Property LLC, Denver, CO (US)

(72) Inventors: Crystal Dawn DOWDS, Portland, OR (US); Kim S. FRANTZ, Boise, ID (US)

(73) Assignee: CenturyLink Intellectual Property LLC, Denver, CO (US)

(21) Appl. No.: 18/897,456

(22) Filed: Sep. 26, 2024

Related U.S. Application Data
(63) Continuation-in-part of application No. 18/474,667, filed on Sep. 26, 2023.
(60) Provisional application No. 63/585,319, filed on Sep. 26, 2023.
(60) Provisional application No. 63/410,598, filed on Sep. 27, 2022.

(51) Int. Cl. H04Q 11/00

(52) U.S. Cl. CPC H04Q 11/0005; H04Q 11/0067; H04Q 2011/0039

(57) ABSTRACT

A network interface device (NID) is provided to accommodate the receipt and transmission of optical signals according to multiple standards in a single customer premises device. This permits the network service provider, among other things, to deliver one NID to any customer premises, whether or not the particular customer premises is currently being served by an optical line terminal (OLT) providing first protocol service or second protocol service. As a network is upgraded (e.g., from first protocol service to second protocol service), the network service provider can connect the customer premises to an OLT providing the upgraded second protocol service and then programmatically alter the NID to transceive signals according to the upgraded standard without requiring a new NID to be delivered or installed at the customer premises.

### CROSS-REFERENCE TO RELATED APPLICATIONS

This application claims the benefit of U.S. Provisional Application No. 63/585,319 filed Sep. 26, 2023, and this application is a continuation-in-part of U.S. application Ser. No. 18/474,667 filed Sep. 26, 2023, which claims the benefit of U.S. Provisional Application No. 63/410,598 filed Sep. 27, 2022, entitled “Network Interface Device and Improved Routing Device,” each of which applications are incorporated herein by reference in their entireties. To the extent appropriate a claim of priority is made to each of the above-referenced applications.

### BACKGROUND

As people become increasingly reliant on broadband network services, fiber-optic network connectivity, which can carry data at high speeds over long distances, is increasingly being extended to terminate at customers' premises. Fiber to the Premises (FTTP) is a form of fiber-optic communication delivery, in which an optical fiber is run in an optical distribution network from a service provider head office all the way to the premises occupied by the subscriber. In some examples, a transition box may be used on the exterior of the premises to run a drop cable to a network interface device that may be located interior to the premises.

The fiber may be terminated at the customer premises at an optical network terminal (ONT) of a network interface device. In some examples, an ONT is also referred to as an optical network unit (ONU). One or more wireless access point(s) and/or wireless extender device(s) inside of the customer premises may also be communicatively coupled to the ONT. Computing devices within the customer premises may then connect to a wireless network facilitated by the wireless access point(s) (and any wireless extender device(s)) to connect to the service provider's network. It is with respect to this general technical environment that aspects of the present application are directed.

### SUMMARY

The present application describes a network interface device comprising: a first laser driver; a second laser driver; an optical splitting apparatus operatively connected to the first laser driver and the second laser driver and configured to transmit a first incoming optical signal of a first wavelength to the first laser driver and transmit a second incoming optical signal of a second wavelength to the second laser driver; a receiving multiplexer, operatively connected to the first laser driver and the second laser driver and configured to transmit either a first electrical signal received from the first laser driver or a second electrical signal received from the second laser driver; and a processing circuit, comprising at least one processor and memory storing instructions; and at least one user port, operatively connected to the at least one processing circuit, and configured to transmit downstream data to a user device. In examples, and when executed by the at least one processor, the instructions cause the processing circuit to: receive a configuration signal from a provider network indicating that the network interface device should operate according to a first passive-optical-network (PON) protocol; provide a first control signal to the receiving multiplexer based on the configuration signal to cause the receiving multiplexer to transmit the first electrical signal to the processing circuit; and extract, from the first electrical signal and based on the first PON protocol, the downstream data.

In aspects, the present application also discloses a network interface device comprising: at least one user port configured to transmit upstream data received from a user device; a processing circuit, operatively connected to the at least one user port and comprising at least one processor and memory storing instructions that, when executed by the at least one processor, cause the processing circuit to: receive a configuration signal from a provider network indicating whether the network interface device should operate according to a first passive-optical-network (PON) protocol or a second PON protocol; generate, from the upstream data and based on the first PON protocol or the second PON protocol, a first electrical signal; and provide a control signal to a transmitting multiplexer based on the configuration signal to cause the transmitting multiplexer to transmit the first electrical signal to a first laser driver or a second laser driver based on the first control signal. In aspects, the network interface device may also comprise the transmitting multiplexer, operatively connected to the processing circuit, the first laser driver, and the second laser driver; the first laser driver, operatively connected to the transmitting multiplexer, and configured to generate a first outgoing optical signal at a first wavelength based on the first electrical signal; the second laser driver, operatively connected to the transmitting multiplexer, and configured to generate a second outgoing optical signal at a second wavelength based on the first electrical signal; and an optical splitting apparatus, operatively connected to the first laser driver and the second laser driver and configured to transmit the first outgoing optical signal at the first wavelength or the second outgoing optical signal at the second wavelength to an optical line terminal of the provider network.

In aspects, the present application also discloses a method, comprising: receiving, by a network interface device (NID), a first configuration signal from a provider network indicating that the NID should operate according to a first passive-optical-network (PON) protocol; causing, in response to the first configuration signal, a transmitting demultiplexer of the NID to transmit an upstream electrical signal comprising upstream data from a processing circuit of the NID to a first laser driver of the NID; converting, by the first laser driver of the NID, the upstream electrical signal to a first optical signal at a first wavelength associated with the first PON protocol; and transmitting the first optical signal to the provider network.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example environment that may include a network interface device bracket on which a network interface device may operate according to an example.

FIG. 2 illustrates a front-left isometric view of a network interface device bracket according to an example.

FIG. 3 illustrates a back-right isometric view of the network interface device bracket of FIG. 2 according to an example.

FIG. 4 illustrates a front view of the network interface device bracket of FIG. 2 according to an example.

FIG. 5 illustrates a side view of the network interface device bracket of FIG. 2 according to an example.

FIG. 6 illustrates a back view of the network interface device bracket of FIG. 2 according to an example.

FIG. 7 illustrates a front view of the network interface device bracket of FIG. 2 including a coupler interconnecting a drop cable connector and a jump cable connector according to an example.

FIG. 8 illustrates a front view a network interface device removably coupled to a network interface device bracket attached to a mounting surface according to an example.

FIG. 9 illustrates a back-right isometric view of the network interface device bracket of FIG. 2 coupled to a network interface device according to an example.

FIG. 10 illustrates a bottom isometric view of the network interface device bracket of FIG. 2 with a network interface device removably coupled to the bracket according to an example.

FIG. 11 illustrates a method for providing a network interface device bracket and cable storage according to an example.

FIG. 12 illustrates a communication system according to an example.

FIG. 13 illustrates an example network interface device and network interface device bracket according to an example.

FIG. 14 illustrates an example network interface device and example wireless routing device according to an example.

FIG. 15 illustrates an example method for configuring a wireless routing device according to an example.

FIG. 16 illustrates another example method for configuring a wireless routing device according to an example.

FIG. 17 illustrates another network interface device according to an example.

FIG. 18 illustrates a method for configuring a network interface device according to an example.

FIG. 19 illustrates another method for configuring a network interface device according to an example.

FIG. 20 illustrates an example operating environment according to aspects of the present application.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. The following detailed description is therefore not to be taken in a limiting sense, and the scope of the present disclosure is defined by the appended claims and their equivalents.

Among other aspects, the present disclosure describes a network interface device (NID). The NID may accommodate the receipt and transmission of optical signals according to multiple standards in a single customer premises device. For example, the NID may be configured to receive and transmit both gigabyte passive optical network (GPON) signals and 10-gigabyte-capable symmetric passive optical network (XGS-PON) signals in a single device. This permits the network service provider, among other things, to deliver one NID to any customer premises, whether or not the particular customer premises is currently being served by an OLT providing GPON service or XGS-PON service. As a network is upgraded (e.g., from GPON service to XGS-PON service), the network service provider can connect the customer premises to an OLT providing the upgraded service (e.g., XGS-PON) and then programmatically alter the NID to transceive signals according to the upgraded standard without requiring a new NID to be delivered or installed at the customer premises. These and other examples will be explained in more detail below with respect to the figures.

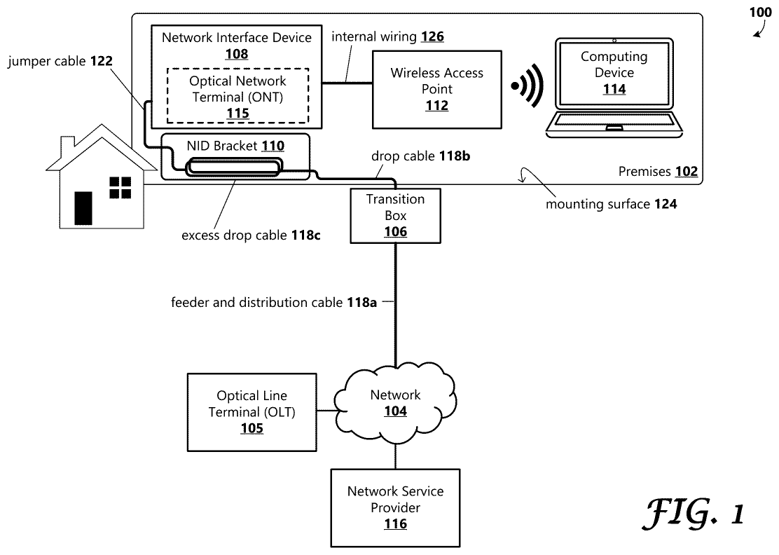

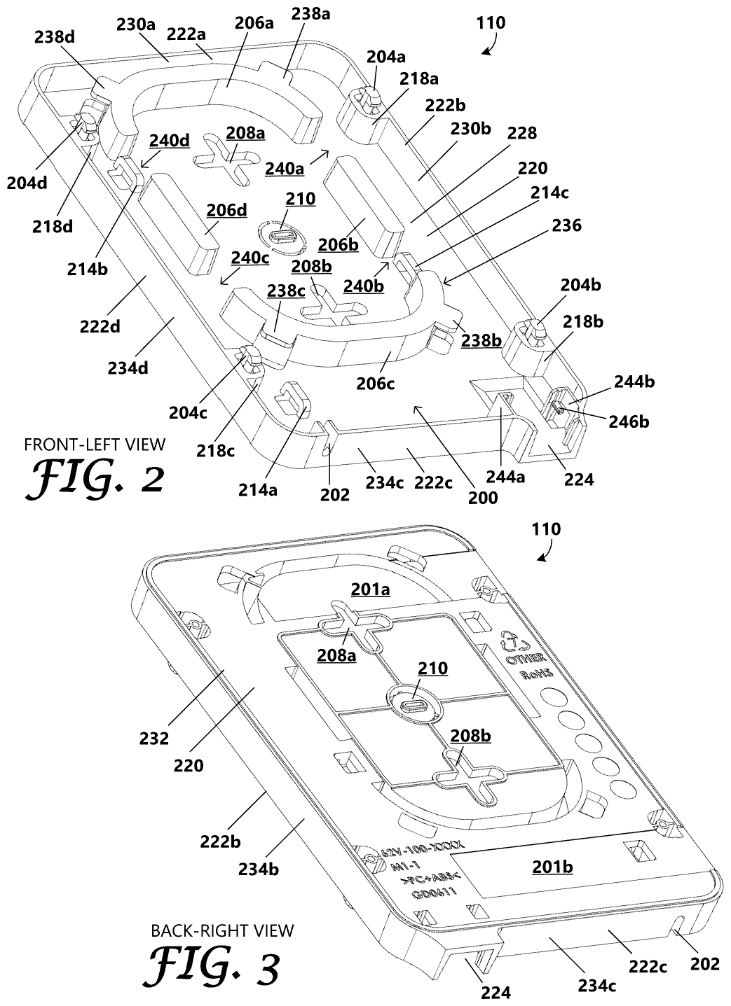

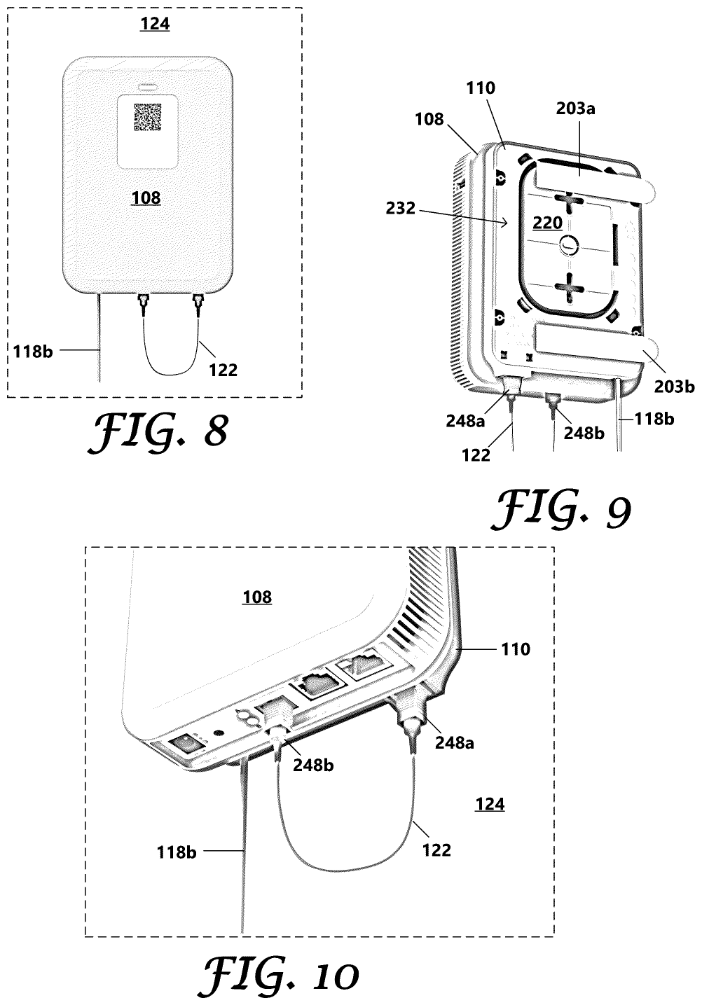

FIG. 1 illustrates an example environment 100 that may include a network interface device (NID) 108, which may be coupled to mount, such as a NID bracket 110 (examples of which are described in detail below with respect to FIGS. 2-10). In some examples, the NID 108 may be provided by or otherwise be associated with a network service provider 116. The network service provider 116 may provide network access, via a network 104 (or combination of networks), to the NID 108. For example, the network service provider 116 may provide wiring/cables 118 that enable a customer to access the network 104 via the NID 108. The NID 108 may serve as an interface between the cables/wiring 118 provided by the network service provider 116 and the wiring on-premises 102, and the NID bracket 110 may generally operate to secure the NID 108 to a mounting surface 124 (e.g., a wall, a low voltage box, a media panel) at a premises 102. The premises 102, for example, may be a home, a multi-dwelling unit, a business, or other location at which network access is desired.

The wiring/cables 118 provided by the network service provider 116 may include fiber-optic cable (sometimes referred to herein as fiber or fiber cable), copper cable, and/or other physical links/circuits that enable customers to access the network 104 via the NID 108. As mentioned above, fiber cable 118 can carry download and upload data at symmetrical high speeds over long distances using pulses of light. With Fiber to the Premises (FTTP) network connectivity, such as shown in the example illustrated in FIG. 1, feed and distribution cable 118a may be run from an optical line terminal (OLT) 105 to a transition box 106, which may be installed outside the premises 102. For instance, the transition box 106 may be used as a termination point for the feeder cable 118a to connect with a first end (not shown) of a drop cable 118b. According to an example, the drop cable 118b may be run from the transition box 106 to the NID bracket 110, on which an optical network terminal (ONT) 115 (e.g., embodied as the NID 108) may be mounted. For example, a fiber network connection may not be able to connect to personal premises equipment (e.g., routers (e.g., wireless access point 112), computing devices 114). Thus, the NID 108 may be a network access device that comprises an ONT 115. According to an aspect, the NID bracket 110 may be configured to receive the drop cable 118b, including a second end of the drop cable 118b and, in some examples, excess drop cable 118c. In some examples, the NID bracket 110 may be further configured to store the excess drop cable 118c and interconnect the second end of the drop cable 118b and a first end of a jumper cable 122 that may have a second end received by the NID 108 in a Wide Area Network (WAN) port. In some examples, the NID 108 may be installed exterior to the premises 102. In other examples, the NID 108 may be installed interior to the premises 102. The NID 108, for example, may be configured to transmit data received from the cable 118 to interior wiring (IW) 126 connected to the wireless access point 112 (e.g., a router or gateway), which can then connect to one or more computing devices 114 associated with the premises 102.

When the NID 108 has been coupled to the network 104 (e.g., via a WAN port associated with the NID 108), network access may be provided to the premises 102 via the wireless access point 112. In some examples, the wireless access point 112 may be included in the NID 108. For example, the NID 108 may have both WAN modem capabilities to connect to the network 104 and router capabilities for providing wired and/or wireless network access to one or more computing devices 114 associated with the premises 102. In other examples, the wireless access point 112 may be a device separate from the NID 108, and may operate as a mesh network device, a router or other such network device that provides wired and/or wireless (WI-FI) network access to the one or more computing devices 114. An example NID 108 that can be incorporated in the environment 100 is described in U.S. patent application Ser. No. 17/569,666 titled “SMART NETWORK INTERFACE DEVICE” filed Jan. 6, 2022, the disclosure of which is incorporated by reference herein in its entirety. For example, the NID 108 may operate as an interface between the network 104 provided by the network service provider 116 and one or more wireless access points 112 associated with the premises 102, where the NID 108 may have at least one port (e.g., ethernet port) through which the wireless access point 112 can be communicatively coupled to the NID 108 via internal wiring (IW) 126, such as an ethernet cable.

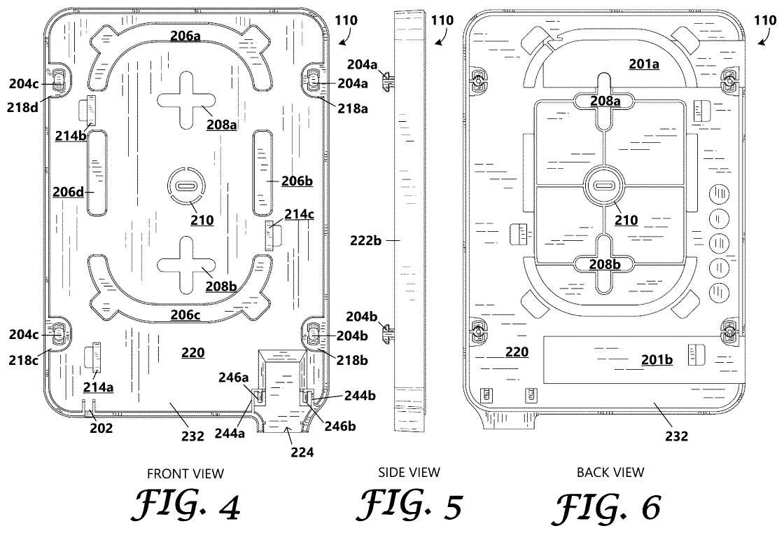

With reference now to FIGS. 2-10, various views of an example NID bracket 110 are illustrated and are described. FIG. 2 illustrates a front-left isometric view, FIG. 3 illustrates a back-right view, FIG. 4 illustrates a front view, FIG. 5 illustrates a right-side view, and FIG. 6 illustrates a back view of the NID bracket 110 according to an example. As shown, the NID bracket 110 may be generally rectangular in shape and may include a back plate 220 having a plurality of sidewalls 222a-d (generally, 222) (e.g., a top sidewall 222a, a right sidewall 222b, a bottom sidewall 222c, and a left sidewall 222d). A front surface 228 of the back plate 220 and interior surfaces 230a-d (generally, 230) of the sidewalls 222 may define an interior housing 200 of the NID bracket 110. A back surface 232 (shown in FIGS. 3 and 6) of the back plate 220 and exterior surfaces 234a-d (generally, 234) of the sidewalls 222 may define the exterior surfaces of the NID bracket 110. The NID bracket 110 may be constructed of various types of materials. In one illustrative example, the NID bracket 110 may be constructed of a polycarbonate or polycarbonate blend material, which, for example, may be shaped into the NID bracket 110 by an injection molding processing method.

In some examples, the NID bracket 110 may include a plurality of device attachment points 204a-d (generally, 204) disposed on the front side of the NID bracket 110 that may be used to removably affix a NID 108 to the NID bracket 110. According to one example and as shown in FIGS. 2 and 4, a plurality of protrusions 218a-d (generally, 218) may protrude inwardly from the interior surfaces 230a-d of the right and left sidewalls 222b, 222d, and each attachment point 204 may extend forwardly from a front-facing surface of the protrusions 218. For example, the attachment points 204 may be aligned with and be shaped to be slidably received by a plurality of slide tracks that may be included in the NID 108. The NID 108 may be removably secured to the NID bracket 110 by sliding the attachment points 204 into the plurality of slide tracks, which may enclose the internal housing 200 of the NID bracket 110. In other examples, a NID 108 may be attached to the NID bracket 110 via another attachment method. In some examples, a lock screw may further be used to further secure the NID 108 to the NID bracket 110.

In some examples, a plurality of attachment openings 208a, 208b (generally, 208) may be defined into the back plate 220, through which a fastener (e.g., a screw) may be extended to fasten the NID bracket 110 to a mounting surface 124. According to an example and as shown, the attachment openings 208 may have a cross shape, which may allow for alignment flexibility both horizontally and vertically. As described above, the mounting surface 124 may include a wall, a low voltage box, or a media panel. According to one example, the attachment openings 208a, 208b may be positioned in the back plate 220 such that the attachment openings 208a, 208b may align with attachment openings of a single gang low voltage box or mounting bracket that may be installed in the mounting surface 124. In other examples, other attachment means may be used to attach the NID bracket 110 to the mounting surface 124. For example, and with reference to FIGS. 3, 6, and 9, one or more flat surfaces 201a-b (generally, 201) (shown in FIGS. 3 and 6) may be formed into or otherwise provided on the back surface 232 of the back plate 220, which may be adapted to receive a hook-and-loop fastener 203a,b (generally 203) (shown in FIG. 9), adhesive strip, or other attachment member.

According to another example, a thickness of the back plate 220 and a height of the sidewalls 222 may be sized such that when the NID 108 is attached to the NID bracket 110, the NID 108 and NID bracket 110 may fit within a standard sized media panel enclosure. In an illustrative example, a depth of the NID bracket 110, measured from the back surface 232 to the top of the sidewalls 222, may range from approximately 10-15 mm. In another illustrative example, the depth of the NID bracket 110, measured from the back surface 232 to the top of the sidewalls 222, may be approximately 12.5 mm.

With reference to FIGS. 2, 3, 4, 6, 7, 9, and 10, the NID bracket 110 may define a cable port 202 through which a portion of drop cable 118 may enter/exit the interior housing 200 of the NID bracket 100. In some examples, the cable port 202 may be disposed on the bottom sidewall 222c of the NID bracket 110. In other examples, the cable port 202 may be disposed elsewhere on a surface of NID bracket 110, such as at the top 222a, right 222b, or left sidewalls 222d, or the back plate 220. As described above, the portion of cable 118 may include a portion of drop cable 118b run from the transition box 106 that may be located exterior to the premises 102.

In some implementations, and with reference to FIGS. 2, 3, 4, and 6, a perforation may be formed into the back plate 220, which may define an alternative cable port 210. The perforation may surround an area of the back plate 220, which, when a force is applied to the area, may allow for the area surrounded by the perforation to be easily removed and for the alternative cable port 210 to be exposed. For example, in some cases, the NID bracket 110 may be installed on one side of a mounting surface 124, and the transition box 106, from which the drop fiber 118b entering the NID bracket 110 may be received, may be located on the opposite side of the mounting surface 124 approximately in alignment with the NID bracket 110. Thus, in some examples, the drop fiber 118b exiting the transition box 106 may be routed through a hole in the mounting surface 124 and may be extended through the alternative cable port 210 defined in the back plate 220 of the NID bracket 110.

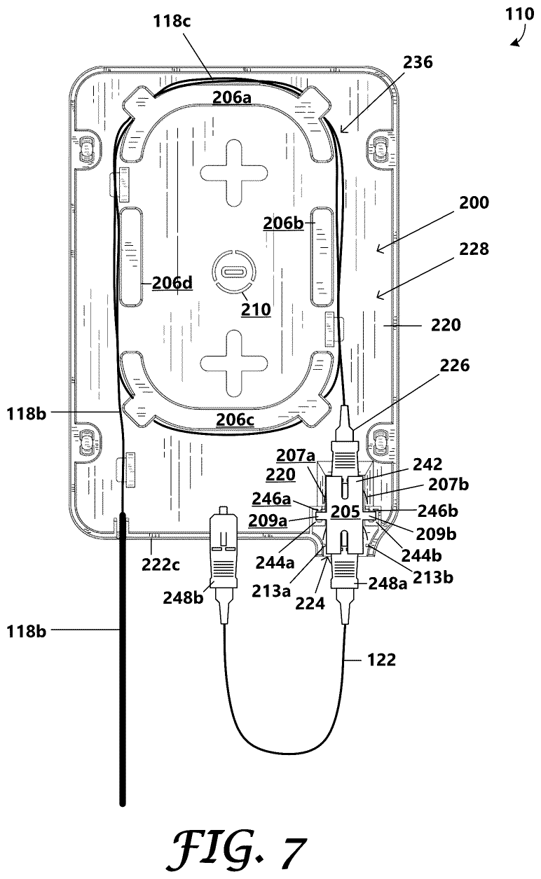

In some examples, the drop cable 118b (a portion of which is shown in FIG. 7) may be pre-connectorized cable. For example, the drop cable 118 may be a pre-measured (e.g., standard) length of cable with connectors 226 attached to each end. The types of connectors 226 may vary. In an illustrative example, the connectors 226 may be angled physical contact (APC) fiber connectors. Pre-connectorized drop cable 118b may offer various advantages, such as installation ease and efficiency and precision and consistency of cable termination, which may ensure that the cable meets standard guidelines and required loss measurements. However, in some cases, when a distance between the transition box 106 and the NID bracket 110 is less than the length of drop cable 118b, a remaining portion of the drop cable (herein referred to as excess drop cable 118c) may be left over. According to an example, the NID bracket 110 may be configured to store excess drop cable 118c in the internal housing 200.

For example, and as shown in FIG. 7, the interior housing 200 may be configured to store a length of cable 118 (e.g., drop cable 118b, excess drop cable 118c) around a reel 236 internal to the housing 200. According to an example, the reel 236 may be defined by the top surface 232 of the back plate 220 and the outwardly facing (e.g., toward the sidewalls 222) sides of one or more raised reel walls 206a-d (generally, 206) extending from the front surface 228 of the back plate 220 and forming a generally elliptical core around which the length of fiber 118 may be wound for storage. In some examples, the reel wall(s) 206 may be configured such that the core formed by the outwardly facing sides of the reel wall(s) 206 may have a radius that is greater than a minimum bend radius of the cable 118. In the examples shown in FIGS. 2 and 4, the NID bracket 110 may include a top reel wall 206a extending forward from a top portion of the front surface 228 of the back plate 220, a right reel wall 206b extending forward from a right-mid portion of the front surface 228, a bottom reel wall 206c extending forward from a bottom portion of the front surface 228, and a left reel wall 206d extending forward from a left-mid portion of the front surface 228. In some examples, the top reel wall 206a and the bottom reel wall 206c may include one or more tabs 238a-d that may generally extend radially outward from a top surface of the top and bottom reel walls 206a, 206c towards the sidewalls 222, which may further define the reel 236 within which the drop cable 118b and/or excess drop cable 118c may be positioned.

In some implementations, and with reference to FIGS. 2, 3, 4, 6, and 7, a perforation may be formed into the back plate 220, which may define an alternative cable port 210 for receiving the drop cable 118b and excess drop cable 118c. The perforation may surround an area of the back plate 220, which, when a force is applied to the area, may allow for the area within the perforation to be easily removed and for the alternative cable port 210 to be opened or exposed. For example, in some cases, the NID bracket 110 may be installed on one side of a mounting surface 124, and the transition box 106, from which the drop cable 118b entering the NID bracket 110 may be received, may be located on the opposite side of a wall and in approximate alignment with the NID bracket 110. Thus, in some examples, the drop cable 118b exiting the transition box 106 may be routed through a hole in and may be extended through the alternative cable port 210 defined in the back plate 220 of the NID bracket 110. In some examples, the reel walls 206 are discontinuous. That is, one or more spaces 240a-d (generally, 240) may be defined between at least two reel walls 206, which, when the drop cable 118b and any excess drop cable 118b is extended through the alternative cable port 210, may provide a channel through which the drop cable 118b can be further routed and wound around the reel 236 defined by the reel walls 206.

In some examples, the NID bracket 110 may further include one or more secure points 214a-c (generally, 214) formed in the front surface 228 of the back plate 220 that may be used to help secure drop cable 118b and any excess drop cable 118b stored in the interior housing 200 of the NID bracket 110. According to an example, each secure point 214 may define an opening through which a cable tie may be extended. For example, the cable tie may be wrapped around the drop cable 118b and/or excess drop cable 118b and an end of the cable tie may be extended through the opening defined in the secure points 214 for securing the drop cable 118b and/or excess drop cable 118b to the NID bracket 110. In some examples, a first secure point 214a may be located between the cable port 202 and the outward facing side of the bottom reel wall 206c, a second secure point 214b may be positioned between the left 206d and top 206a reel walls, and a third secure point 214c may be positioned between the right 206b and bottom 206c reel walls. In one example, the drop cable 118b may be run from the transition box 106, extended through the cable port 202, and routed by and secured to the first secure point 214a. The drop cable 118b may be further routed along the outward facing side of the left reel wall 206d by the second secure point 214b, along the outward facing sides of the top reel wall 206a and right reel wall 206b by the third secure point 214c toward a coupler receptacle 224, where a connector 226 attached to the end of the drop cable 118b may be connected to a coupler 242 (described below with reference to FIG. 7). When the drop cable 118b has been routed past the right reel wall 206b and the third secure point 214c, and when there is excess drop cable 118c left, the excess drop cable 118c may be wrapped, e.g., clockwise around the reel 236 and secured at the second 214b and third 214c attachment points by a cable tie. Or, in another example, the alternative cable port 210 in the back plate 220 may be opened as described above, and the drop cable 118b may be run from the transition box 106, through a wall, and extended through the alternative cable port 210. The drop cable 118b may be further routed through an opening 240 defined between two reel walls 206 (or defined through a reel wall 206) to the reel 236, where the cable (and any excess drop cable 118c) may be wound clockwise around the reel 236 to extend the end of the drop cable 118b to the coupler 242 in the coupler receptacle 224. The drop cable 118b and any excess drop cable 118c may then be secured to the NID bracket 110 via wrapping a cable tie around the cable and securing the cable to the secure points 214.

With reference to FIGS. 2, 4, and 7, in some examples, the NID bracket 110 may include a coupler receptacle 224. For example, the coupler receptacle 224 may be formed into a sidewall 222 and may be shaped and configured to receive and securely hold the coupler 242 mentioned above. According to one example, the coupler receptacle 224 may be formed into the bottom sidewall 222c and may include a pair of sides 244a, 244b. For example, a left side 244a may be configured to receive a first flange 209a of the coupler 242 and a right side 244b may be configured to receive a second flange 209b of the coupler 242. In some examples, a first protrusion 246a may extend from a top wall of the left side 244a, which may engage a first bore defined in the first flange 209a of the coupler 242, and a second protrusion 246b may extend from a top wall of the right side 244b, which may engage a second bore defined in the second flange 209b of the coupler 242. For example, the coupler 242 may be snapped into the coupler receptacle 224, with the pair of flanges 209a, 209b inserted into the pair of sides 244a, 244b and held securely by the protrusions 246 inserted into the bores of the pair of flanges 209a, 209b.

According to some examples, the coupler 242 may interconnect the connector 226 of the drop cable 118b to a first connector 248a at one end of the jumper cable 122, which may connect to the NID 108 via a second connector 248b located at the other end of the jumper cable 122. For example, rather than connecting the drop cable 118b directly to the NID 108, the drop cable 118b may be securely coupled to the coupler 242, which may be securely held in the coupler receptacle 224 included in the NID bracket 110. The jumper cable 122 may be exposed, which may be handled by the customer in various circumstances, such as to troubleshoot the NID 108, remove or replace the NID 108, etc. Thus, if breakage of a cable were to occur due to customer-handling, the breakage may be more likely to occur to the exposed jumper cable 122, which may be a short length (e.g., approximately 6 in.) of cable, and which may be less costly to replace than the more-protected drop cable 118b.

The coupler 242 may be one of various types of couplers. According to an example, the coupler 242 type may correspond with the type of connector 226 included on the drop cable 118 and the type of connector 248a included on the jumper cable 122. In some examples, the coupler 242 may be a Subscription Channel (SC) adapter, and in further examples, the coupler 242 may be an SC-APC adapter. As should be understood, that the scope of the present disclosure is not limited to SC-type or SC-APC-type adapters. The coupler 242, for example, may include a main body 205 with the pair of flanges 209a, 209b located on the exterior of the main body 205. The flanges 209a, 209b may be configured to support the coupler 242 in the coupler receptacle 224.

The coupler 242 may further include a first pair of retaining clips 207a, 207b disposed on the exterior of the main body 205 and positioned between the flanges 209a, 209b and the top end of the coupler 242. In some examples, the coupler 242 may further include a second pair of retaining clips 211a, 211b disposed on the exterior of the main body 205 and positioned between the flanges 209a, 209b and the bottom end of the coupler 242. In some examples, the retaining clips 207a, 207b, 211a, 211b may be metal springs that may be compressed against the main body 205 when inserting the coupler 242 into the coupler receptacle 224, and that may decompress and spring outward when the coupler 242 is seated in the coupler receptacle 224 (with the flanges 209a, 209b inserted into the sides 244a, 244b and with the protrusions 246a, 246b extending into the bores defined in the flanges 209a, 209b). For example, the first pair of retaining clips 207a, 207b may abut top-facing surfaces of the sides 244a, 244b and may provide leverage against a downward pulling force of the coupler 242 (e.g., such as when unplugging the jumper cable 122 from the coupler 242). Additionally, the second pair of retaining clips 211a, 211b may abut top-facing surfaces of a pair of tabs 213a, 213b that may extend into the coupler receptacle 224 from the interior surface of the bottom sidewall 222c, and that may provide leverage against a downward pulling force of the coupler 242.

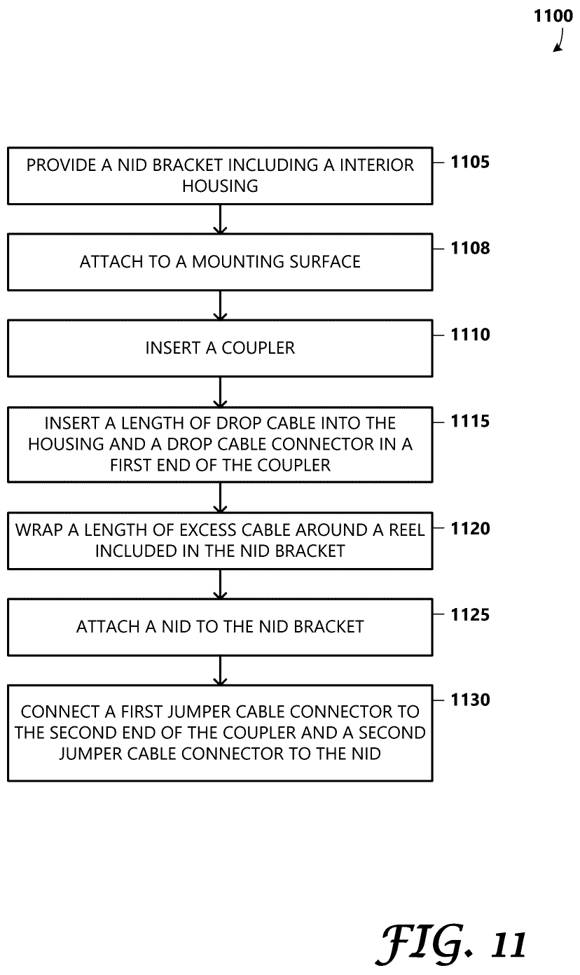

FIG. 11 illustrates a method 1100 for providing a NID bracket 110 that may secure a NID 108 to a mounting surface 124 and connect the NID 108 to a network 104 according to an example. At operation 1105, the NID bracket 110 may be provided. For example, the NID bracket 110 may be formed from a piece of plastic, metal, or other material. In an illustrative example, the NID bracket 110 may be formed into a shape described above and shown in the examples illustrated in FIGS. 2-10 via injection molding from a polycarbonate or polycarbonate blend material. According to an example, the NID bracket 110 may include a housing 200 defined by the front surface 228 of the back plate 220 and the interior surfaces 230 of a plurality of sidewalls 222 (e.g., the top sidewall 222a, the right sidewall 222b, the bottom sidewall 222c, and the left sidewall 222d). In some examples, the NID bracket 110 may further include a plurality of attachment openings 208 defined in the back plate 220 for inserting a plurality of fasteners for removably attaching the NID bracket 110 to a mounting surface 124. In some examples, the NID bracket 110 may further include the cable port 202 defined in a sidewall configured to receive a length of drop cable 118b. In some examples, the NID bracket 110 may further include a reel 236 defined by outwardly facing sides of one or more raised reel walls 238 extending from the front surface 228 of the back plate 220 configured to provide a core around which a portion of the length of drop cable 118b can be wound and stored. In some examples, the NID bracket 110 may further include the coupler receptacle 224 configured to hold a coupler 242 adapted to interconnect a second end of the drop cable 118b and a first end of a jumper cable 122. In some examples, the NID bracket 110 may further include a plurality of forward extending attachment points 204 for removeable attachment to a NID 108 to the NID bracket 110 for securing the NID 108 to the mounting surface 124, wherein the second end of the jumper cable 122 may be received in a WAN port included in the NID 108. In some examples, the NID bracket 110 may further include one or more other components described above.

At operation 1108, the NID bracket 110 may be attached to a mounting surface 124. In one example, screws or other fasteners may be inserted through the attachment openings 208 defined into the back plate 220. In another example, hook-and-loop fasteners 203 may be attached to flat surfaces 201 formed into the back surface 232 of the back plate 220 and then removably attached to the mounting surface 124.

At operation 1110, a coupler 242 may be inserted into the coupler receptacle 224. For example, the coupler 242 may be inserted into and seated in the coupler receptacle 224, which may include engaging the protrusions 246a, 246b included in the coupler receptacle 224 with the bores defined in the flanges 209a, 209b of the coupler 242. In one example, when inserting the coupler 242, the coupler 242 may be aligned with the coupler receptacle 224 such that the flanges 209a, 209b may be inserted into the coupler receptacle 224 below the protrusions 246a, 246b. This may cause the retaining clips 207a, 207b, 211a, 211b to compress against the main body 205 when pushing the coupler 242 upward toward the protrusions 246a, 246b, until the coupler 242 is seated in the coupler receptacle 224, where the protrusions 246a, 246b may be extended through the bores defined in the flanges 209a, 209b and the retaining clips 207a, 207b, 211a, 211b may be decompressed and spring outward to help secure the coupler 242 from movement when forces may be applied (e.g., when plugging and unplugging cable connectors 226, 248a from the coupler 242).

At operation 1115, a length of drop cable 118b may be run between a transition box 106 and the NID bracket 110, where, in some examples, the first end of the drop cable 118b may be interconnected with the feeder and distribution cable 118a at the transition box 106, and the second end of the drop cable 118b may be inserted into the interior housing 200 of the NID bracket 110. For example, the second end of the drop cable 118b may be inserted into the cable port 202 or alternate cable port 210 and routed around the reel 236 defined in the housing 200 to the coupler 242. The connector 226 attached to the second end of the drop cable 118b may be inserted into the top end of the coupler 242. In some example, if there is an excess length of drop cable 118b, the excess drop cable 118c may be wrapped around the reel 236 at operation 1120. Additionally, one or more cable ties may be inserted through the secure points 214, wrapped around the drop cable 118b and excess drop cable 118c, and fastened.

At operation 1125, a NID 108 may be removably attached to the NID bracket 110. For example, the attachment points 204 extending forward on the front side of the NID bracket 110 may be located and shaped to be slidably received by a plurality of slide tracks that may be included in the NID 108. The NID 108 may be removably secured to the NID bracket 110 by aligning the attachment points 204 with the slide tracks and sliding the attachment points 204 into the plurality of slide tracks.

At operation 1130, a first connector 248a of a jumper cable 122 may be inserted into the bottom end of the coupler 242, which may interconnect the drop cable 118b and jumper cable 122. In some examples, a second connector 248b of the jumper cable 122 may be inserted into the NID 108 in a Wide Area Network (WAN) port. Accordingly, the NID 108 may be connected to the network 104 via the jumper cable 122 connection to the coupler 242 of the NID bracket 110.

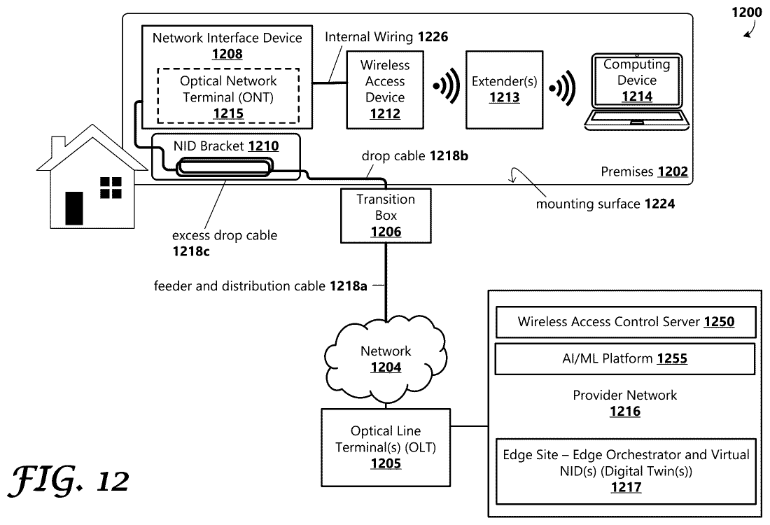

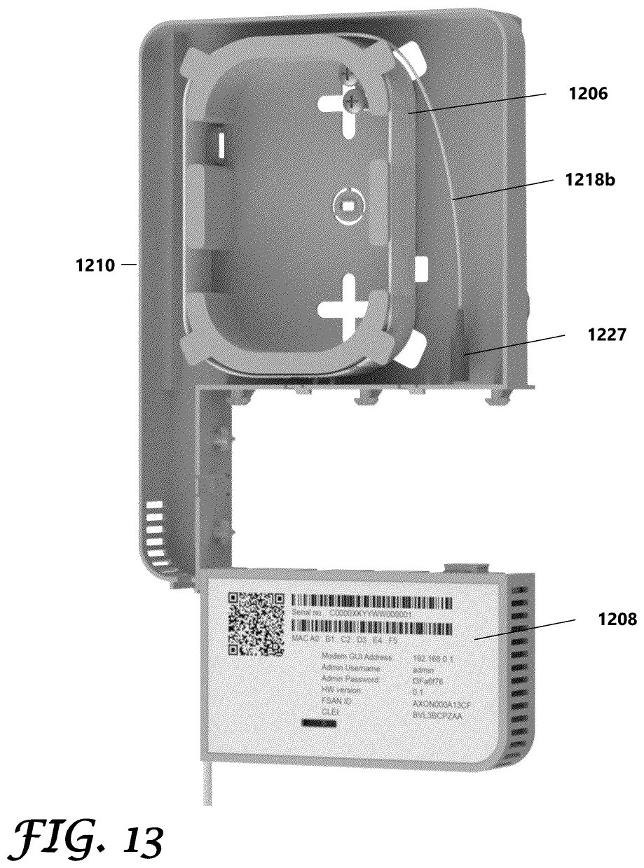

FIG. 12 illustrates an example environment 1200 that may include a network interface device (NID) 1208, which may be coupled to a mount, such as a NID bracket 1210 (examples of which are described in detail below). In some examples, the NID 1208 may be provided by or otherwise be associated with a network service provider. The provider network 1216 may provide WAN (e.g., Internet) network access, including through network 1204 (and/or a combination of other networks), to the NID 1208. In examples, the network 1204 may comprise an optical distribution network comprising one or more passive optical splitters, optical connectors, and optical cables that connect the OLT(s) 1205 to the transition box 1206 and/or to the NID 1208. For example, the network service provider may provide wiring/cables 1218 that enable a customer to access the network 1204 and/or provider network 1216 through the NID 1208 (and in some examples, the transition box 1206). The NID 1208 may serve as an interface between the cables/wiring 1218 provided by the network service provider and the wireless access device 1212 or a directly wired computing device 1214. The NID bracket 1210 may generally operate to secure the NID 1208 to a mounting surface 1224 (e.g., a wall, a low voltage box, a media panel) at a premises 1202. The premises 1202, for example, may be a home, a multi-dwelling unit, a business, or other location at which network access is desired.

The wiring/cables 1218 provided by the network service provider may include fiber-optic cable (sometimes referred to herein as fiber or fiber cable), copper cable, and/or other physical links/circuits that enable customers to access the network 1204 via the NID 1208. As mentioned above, fiber cable 1218 can carry download and upload data at symmetrical high speeds over long distances using pulses of light. With Fiber to the Premises (FTTP) network connectivity, such as shown in the example illustrated in FIG. 12, feed and distribution cable 1218a may be run (directly or indirectly) from an OLT 1205 through network 1204 to a transition box 1206, which may be installed outside the premises 1202. In some examples, the OLT 1205 is part of the provider network 1216. The OLT 1205 may comprise multiple OLT devices. For example, a local or central office of a provider network 1216 may include one or more OLT devices configured to transceive optical signals according to multiple passive optical network (PON) protocols. For example, the OLTs 1205 may be configured to receive and transmit both gigabyte passive optical network (GPON) signals and 10-gigabyte-capable symmetric passive optical network (XGS-PON) signals. In some examples, a central office (or edge site 1217) of the provider network 1216 may initially comprise an OLT to transceive signals according to a first PON protocol and then later be upgraded with a new (or additional) OLT to transceive signals according to a second PON protocol. In examples discussed herein, the NID 1208 may operate to transceive signals at the premises 1202 after an upgrade of an OLT 1205 without requiring a new NID 1208 to be installed at the customer premises 1202.

In examples, the transition box 1206 may be used as a termination point for the feeder cable 1218a to connect with a first end (not shown) of a drop cable 1218b. According to an example, the drop cable 1218b may be run from the transition box 1206 to the NID bracket 1210, on which an optical network terminal (ONT) 1215 (e.g., embodied as part of the NID 1208) may be mounted. For example, a fiber network connection may not be able to connect to personal premises equipment (e.g., routers (e.g., wireless access device 1212), computing devices 1214). Thus, in examples, the NID 1208 may be a network access device that comprises an ONT 1215. According to an aspect, the NID bracket 1210 may be configured to receive the drop cable 1218b, including a second end of the drop cable 1218b and, in some examples, excess drop cable 1218c. In some examples, the NID bracket 1210 may be further configured to store the excess drop cable 1218c and interconnect the second end of the drop cable 1218b to the NID 1208. In some examples, as explained further below, no jumper cable between the drop cable 1218b and the NID 1208 may be necessary. In some examples, the NID 1208 may be installed exterior to the premises 1202. In other examples, the NID 1208 may be installed within the interior of the premises 1202. In other examples, the NID 1208 may comprise all hardened elements that are suitable for indoor or outdoor use in extreme temperatures (e.g., I-temp standards compliant). The NID 1208, in examples, may be configured to transmit data received from the cable 1218 to internal wiring 1226 (such as an Ethernet cable) connected to the wireless access device 1212 (e.g., a router or gateway), which can then connect wirelessly, in examples, to one or more extender device(s) 1213 and/or to one or more computing devices 1214 associated with the premises 1202. In other examples, one or more computing devices 1214 may be directly wired into a port of the NID 1208.

When the NID 1208 has been coupled to the network 1204 (e.g., via a WAN port associated with the NID 1208), network access may be provided to the premises 1202 via the wireless access device 1212 and/or extender device(s) 1213. In some examples, the wireless access device 1212 may be included in the NID 1208. For example, the NID 1208 may have both WAN modem capabilities to connect to the network 1204 (and provider network 1216) and router capabilities for providing wired and/or wireless network access to one or more computing devices 1214 associated with the premises 1202. In other examples, the wireless access device 1212 may be a device separate from the NID 1208, and may operate as a mesh network device, a router, a gateway, or other such network device that provides wired and/or wireless (WI-FI) network access to the one or more computing devices 1214.

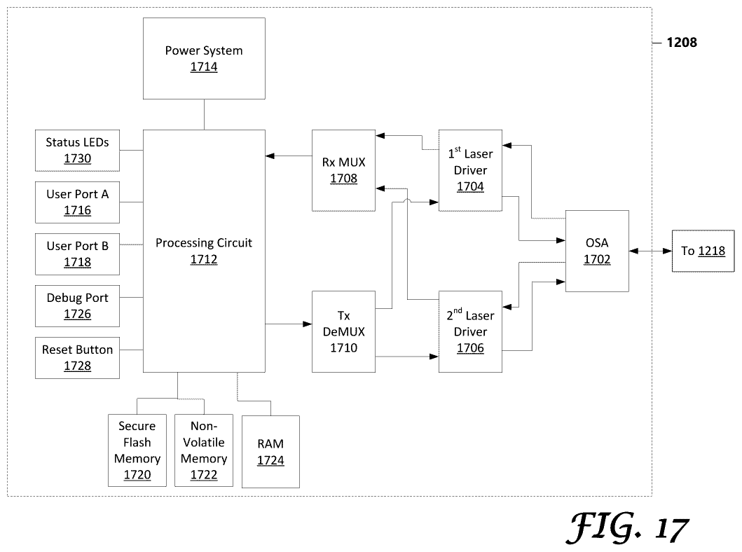

An example NID 1208 that can be incorporated in the environment 1200 is described in U.S. patent application Ser. No. 17/569,666 titled “SMART NETWORK INTERFACE DEVICE” filed Jan. 6, 2022, the disclosure of which is incorporated by reference herein in its entirety. Another example NID 1208 is described below with respect to FIG. 17. In examples, the NID 1208 may operate as an interface between the network 1204 provided and one or more wireless access points 1212 associated with the premises 1202, where the NID 1208 may have at least one port (e.g., Ethernet port) through which the wireless access device 1212 can be communicatively coupled to the NID 1208 via internal wiring (IW) 1226, such as an Ethernet cable.

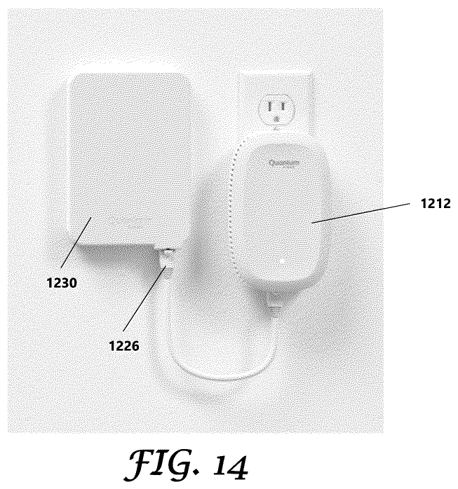

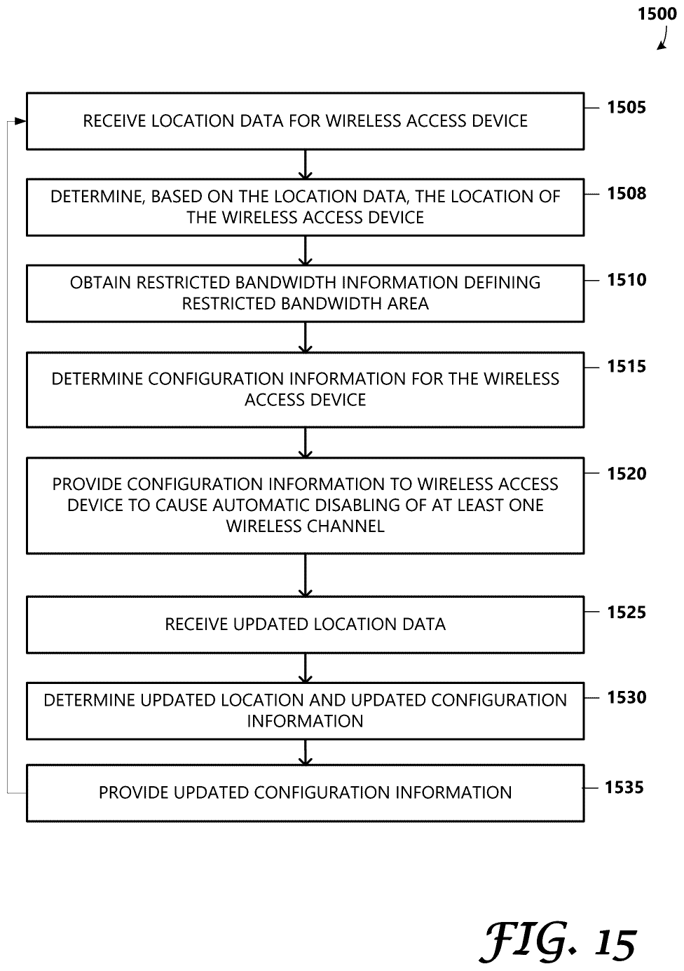

In some examples, the NID 1208 may be similar to NID 108. One alternative example of a NID 1208 is illustrated in FIG. 13. In this example of FIG. 13, the NID 1208 has a smaller form factor and is removably attached to the NID bracket 1210 via connection points around an outer edge of the NID 1208. For example, the NID bracket 1210, as shown in FIG. 13, may include multiple protrusions that cooperate with receiving elements formed in or on the NID 1208 to allow the NID 1208 to be snapped onto or off of the NID bracket 1210. When the NID 1208 is attached to the NID bracket 1210, the NID 1208 completes a surface over which a face plate 1230 (see FIG. 14) is attached to cover the NID bracket 1210 and the NID 1208. As such, when the unitary face plate 1230 (see, e.g., FIG. 14) is installed, the NID bracket 1210 and NID 1208 appear as a single unit. In examples, the NID 1208 may include an ONT 1215 that is directly connectable to the drop cable 1218b, the excess portion of which (1218c) may be looped around the one or more reel walls 1206 before being connected via a connector 1227 to the NID 1208. In examples, the reel walls 1206 and other drop-cable management features of NID bracket 1210 may be similar to the reel walls 206 and drop-cable management features of NID bracket 110 in FIGS. 1-10.

In examples, the jumper cable 122, described above, can be omitted. For example, the connector 1227 can be secured to the NID bracket 1210 such that, when the NID 1208 is installed (e.g., snapped onto the NID bracket 1210), the connector 1227 is automatically connected to the ONT 1215 of NID 1208. For example, contacts of connector 1227 may be exposed and automatically connect to contacts of a receiving connector of the ONT 1215 when the NID 1208 is secured to the NID bracket 1210. In other examples, the connector 1227 may be manually plugged into the NID 1208 after the NID 1208 is snapped onto the NID bracket 1210.

In examples like depicted in FIG. 13, because the NID 1208 is modularly constructed, it can be swapped out for a new or updated NID 1208 with relatively little labor. For example, face plate 1230 can be removed, the drop cable 1218b can be disconnected (if necessary), the internal wiring (e.g., Ethernet cable) 1226 can be disconnected, and then the NID 1208 can be removed by releasing the tabs on the NID bracket 1210 that hold the NID 1208 in place. A new NID 1208 can then be snapped into place, the two cables (drop cable 1218b and Ethernet cable 1226) are reattached (if necessary), and the face plate 1230 can be snapped back into place. In examples, this procedure can easily be performed by a customer rather than the service provider being required to dispatch a technician.

In some examples, particularly if the premises 1202 is a multi-dwelling unit (MDU), the system 1200 may also include a virtual MDU switch, which can accommodate multiple (e.g., 24) NIDs 1208 and multiple (e.g., 24) Ethernet connections. In examples, this may allow a drop cable to terminate in multiple Ethernet connections to different customers, which are multiplexed using the switch. For example, multiple wireless access points 1212 can be supported to create multiple wireless networks that can be accessed by multiple computing devices 1214 of different customers within the same premises.

In examples, the NID 1208 may include a micro-controller and other circuitry that fully virtualizes passive optical network protocol capability (such as XGS-PON (also known as the G.987 standard)), which (among other things) allows the NID 1208 to have very low power requirements. In examples, the NID 1208 is powered via a Power over Ethernet connection to a wireless access device 1212, thereby freeing up a power outlet. For example, internal wiring 1226 may comprise an Ethernet cable. The wireless access device 1212 may include a power supply that is adapted to plug into a wall outlet, as shown in FIG. 14. The wireless access device 1212 may also be adapted to act as an Ethernet power sourcing device for the network interface device 1208 to which it may be connected, e.g., by an Ethernet cable. For example, the NID 1208 may include an Ethernet power receiver, and the internal wiring 1226 may comprise a high-quality Ethernet cable (E.g., CAT5e, CAT6, or greater).

In examples, the wireless access device 1212 comprises a wireless routing device, such as a router or gateway. The wireless access device 1212 may facilitate a wireless local area network (LAN) for the premises 1202. In examples, one or more extender devices 1213 may also be utilized to extend the reach of the wireless LAN. In examples, extender device(s) 1213 may comprise one or more wireless booster, repeater, extender, and/or mesh router. In other examples, multiple wireless access points 1212 may be used in a premises 1202. In examples, the wireless access point(s) 1212, the extender device(s) 1213, and the computing device(s) 1214 communicate wirelessly using a wireless protocol, such as Wi-Fi. In examples, the wireless access point(s) 1212, the extender device(s) 1213, and the computing device(s) 1214 communicate wirelessly using the Wi-Fi 7 protocol.

Among other things, a wireless protocol (such as Wi-Fi 7) may offer the use of multiple channels on a frequency spectrum. However, certain channels in certain parts of the world may be restricted, while those same channels in different geographic areas may be legal to use for wireless access point(s) and extender device(s). For example, 2.4 GHz Wi-Fi has 14 channels, but only channels 1 through 11 are legal to use in the United States in full-power mode, while channels 12-14 are not generally useable in the United States. By contrast, channels 12 and 13 are legal to use, for example, in Europe and Japan. Further, certain additional channels may be available for use, but not within a certain threshold distance from particular locations (such as airports or military bases, etc.).

In examples, the wireless access point(s) 1212 may include a location transceiver, such as a global positioning satellite (GPS) transceiver, to allow the wireless access point(s) 1212 or associated systems to (a) determine the position of the wireless access point; (b) determine whether that position is within a restricted area; and (c) if so, automatically disable access to the restricted channels/bandwidth and, if not, permit access to the restricted channels/bandwidth. A similar location transceiver may be provided in the extender device(s) 1213.

For example, a wireless access device 1212 may periodically report its location data (e.g., current GPS position information) to the provider network 1216. Provider network 1216 may comprise, for example, one or more wireless access control server 1250 the receives reported GPS positions from various wireless access points 1212 connected to the provider network 1216. In other examples, the provider network 1216 may use other information to estimate the location of the wireless access point, including determining the location of the transition box 1206, determining the location of the OLT 1205 to which the network interface device 1208 is connected, determining a stored address for a customer to which the network interface device 1208 is provisioned, etc. The provider network 1216 may store, or have access to, restricted bandwidth information, including geolocation information for areas in which certain bandwidth or channels are not permitted for civilian use. In examples, the provider network 1216 (or another system available to the provider network 1216 or the wireless access device 1212) may then send a signal to the wireless access device 1212 to cause the wireless access device 1212 to automatically disable the use of any bandwidth or channels not currently permitted for use in the area where the wireless access device 1212 reported its location (or the estimated location of the wireless access device 1212). For example, a wireless access control server 1250 of the provider network 1216 may send control signals to such wireless access points 1212 to limit their use of certain channels based on their determined locations. In examples, the disabling of the prohibited channels based on the determined location of the wireless access device 1212 is performed programmatically in response to the signal from the provider network 1212 and does not require any user interaction.

In examples, the restricted bandwidth information may include longitude and latitude information to define restricted areas, including national, state, or municipal borders, areas around sensitive/restricted locations (e.g., within 30 miles of an airport or military facility), etc. In examples, the restricted bandwidth information stored by (or available to) the provider network 1216 may be regularly updated as laws and/or restricted areas change. In this manner, a wireless access device 1212 can be equipped to operate in all available bandwidths/channels; however, depending on where the wireless access device 1212 is deployed, the operation of the wireless access device 1212 may be automatically restricted to only the bandwidth/channels allowed in that area. This is advantageous for a service provider in that the wireless access device 1212 automatically adapts to changing rules/restrictions without hardware changes or upgrades. Further, this permits customers to move wireless access points 1212 from one premises to another, while the wireless access device 1212 is able to self-configure for use of allowable, non-restricted bandwidth/channels at the new premises location(s). Further, adding a geolocation transceiver to the wireless access device 1212 permits the service provider greater visibility into the location of inventoried devices connected to its network.

As discussed, in examples, the NID 1208 may comprise relatively low-cost hardware and minimal memory and processing capability by moving management, control, and certain services normally performed by the NID 1208 to a cloud-based environment. For example, the provider network 1216 may include multiple edge sites (also referred to as edge networks or edge clouds) 1217. In examples, edge sites 1217 may be geographically dispersed and include computing and storage resources and services that are geographically or logically near computing devices requesting such services. For example, the NID 1208 may be configured to communicate with the edge site 1217 that is geographically or logically closest to it within the provider network 1216 in order to reduce latency and unnecessary traffic across provider network 1216. In examples, the OLT 1205 may be located within an edge site 1217.

In examples, each edge site 1217 may include an edge orchestrator and a virtual NID (also referred to as a virtual CPE), which may operate as the digital twin of the NID 1208. In examples, the NID 1208 may operate relatively low-consumption microservices that provide information from the NID 1208 back to the edge site 1217. The edge orchestrator may comprise a software-defined network (SDN) controller that operates to pull such information from the NID 1208 and/or the virtual NID at edge site 1217 and provide it to other devices or services (e.g., a core network orchestrator). For example, the NID 1208 and/or virtual NID at edge site 1217 may report any number of operating parameters, such as inventory information, device status, performance, statistics, events, faults, log data, alarms, network topology data, etc. The edge orchestrator may also be configured to implement any configuration changes at the NID 1208 or the virtual NID. Further, the edge orchestrator may coordinate any testing of configuration changes on the virtual NID or NID 1208 prior to implementing them. In examples, in order to add additional capacity to the NID 1208 (such as additional RAM or other memory, or certain applications or services), those resource can be added more cheaply and quickly to the virtual NID at the edge site 1217 than to the NID 1208.

In examples, the majority of processing takes place the virtual machines resident at the edge site(s) 1217, rather than at the NID 1208. This allows for a massive number upgrades, updates, security patches, etc. to be rolled out in a very short amount of time because the edge site(s) 1217 are readily accessible to the administrators of the provider network 1216, and the virtual machines can be vendor agnostic (not tied to the firmware or other restrictions of the particular vendor(s) of the customer premise equipment, such as NID 1208). In examples, the virtual NIDs of the edge site(s) can be architected to automatically report their operating parameters, rather than having to poll NIDs 1208 using a different protocol for each vendor of the NID 1208.

In addition, the information that is reported by the NID 1208 and/or the virtual NID may be fed to an artificial intelligence/machine learning (AI/ML) platform 1255. The AI/ML platform 1255 may use information from both the virtual machines of the edge site(s) 1217 and telemetry data from the NID 1208 (or other customer premise equipment) in order to predict and/or monitor the effects of configuration changes on the networks and equipment of provider network 1216 as a whole, or of any portion thereof. In addition, the edge orchestrator (e.g., SDN controller) of edge site 1217 can be used to dynamically provision and/or reconfigure the NID 1208, or other customer premise device(s), as needed. For example, the edge orchestrator (e.g., SDN controller) of edge site 1217 can be used to dynamically provision and/or reconfigure the NID 1208 to operate in a different PON mode (e.g., according to a different PON protocol), as needed and as explained below.

FIG. 15 depicts an example method 1500 according to aspects of the present application. In examples, some or all of the operations of method 1500 may be performed by one or more wireless access control server, such as the wireless access control server 1250 of FIG. 12.

In this example, the method begins with operation 1505, where location data for a wireless access device is received. In some examples, the location data may comprise location data (e.g., longitude and latitude coordinates) from a global positioning satellite (GPS) transceiver of the wireless access device. In other examples, the location data may comprise location data for a device to which the wireless access device is operatively connected, such as NID 1208, transition box 1206, OLT 1205, etc. Further, in some examples, the receiving of the location data may comprise querying, by a wireless access control server of a provider network, the wireless access device for the location data and receiving such location data in response to such query. In some examples, the query may be triggered by the wireless access device being connected to the provider network (e.g., by being operatively connected to NID 1208, or otherwise.

Flow proceeds to operation 1508, where the location of the wireless access device is determined based on the location data. For example, operation 1508 may comprise extracting longitude and latitude information from a message received from the wireless access device. In other examples, operation 1508 may comprise estimating a location of the wireless access device from stored location data associated with one or more other network elements to which the wireless access device is operatively connected.

Flow proceeds to operation 1510, where restricted bandwidth information defining a restricted bandwidth area is obtained. In examples, the wireless access control server 1250 may store, or have access to, the restricted bandwidth information. The restricted bandwidth information may include, in examples, the longitudinal and latitudinal boundaries of a restricted area and an identification of the one or more channels over which wireless communication is prohibited. For example, the restricted bandwidth information may define a restricted area in which an airport is located and bandwidth ranges in which private communications are prohibited while within the restricted area. The wireless access control server 1250 may also store information mapping restricted bandwidth information to defined channels for certain wireless standards (such as WiFi) to determine which wireless channels of a wireless access device would be prohibited from being operated within the restricted area.

Flow proceeds to operation 1515, where configuration information is determined for the wireless access device. In some examples, a determination is made whether the location of the wireless access device is within a restricted area. If not, then the configuration information may include no limitations on the wireless channels that are eligible to be used, or a null set of configuration information may be determined. If the wireless access device is determined to be located within a restricted area, however, the configuration information may include instructions to disable any wireless channels that are prohibited from being used within the determined restricted area.

Flow proceeds to operation 1520, where the configuration information is sent to the wireless access device. In the depicted example, the configuration information includes instructions to cause the wireless access device to disable at least one wireless channel that the wireless access device would otherwise be configured to be capable of using. In examples, the disabling of the restricted channel(s) happens automatically, without requiring user intervention, so that the wireless access device can remain compliant with any restrictions known to the service provider.

Flow proceeds to operation 1525, where updated location data is received. In examples, if the wireless access device is disconnected in a first location and reconnected in a second location (e.g., the owner of the wireless access device has moved to a new home or business location), then new location data may be received. In some examples, the generation of location data may be triggered upon startup of the wireless access device, or upon determining that a wireless access device has been connected to the provider network in a new location (e.g., connected to a different NID 1208, transition box 1206, or OLT 1205, etc.). Updated location data can be generated and received in a manner similar to operation 1505.

Flow proceeds to operation 1530, where an updated location for the wireless access device and updated configuration data are determined. Operation 1530 may comprise similar operations as operations 1508, 1510, and 1515, among other possibilities.

Flow proceeds to operation 1535, where updated configuration information is provided to the wireless access device. For example, the determined updated location of the wireless access device may result in a change to the configuration information. For example, where the initial configuration information may have caused a first channel to be disabled due to the initial location of the wireless access device, the wireless access device may have been moved to a second location that is not within a restricted area. In this instance, the first channel that was previously disabled may be re-enabled automatically by the implementation of the updated configuration information. Or, in other examples, the update in determined location may cause updated configuration information to be generated that disables at least one additional channel than was originally disabled.

In examples, some or all of the operations of method 1500 may be repeated for additional wireless access devices. For example, a second wireless access device that is in a different location from the first wireless access device may receive different configuration information (causing disabling of a different selection or number of channels than the configuration information for the first wireless access device).

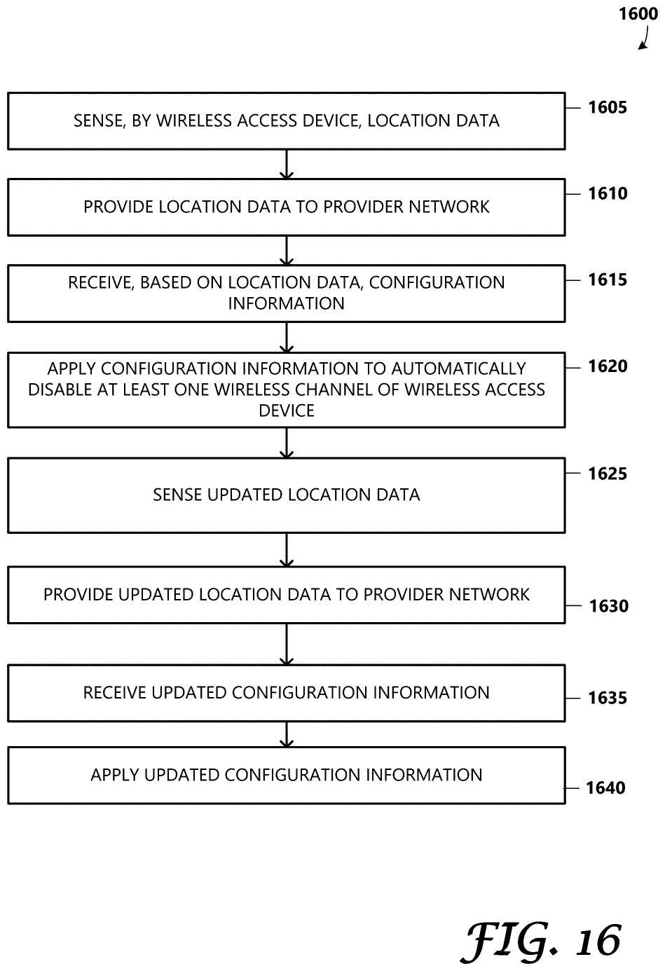

FIG. 16 depicts an example method 1600 according to aspects of the present application. In examples, some or all of the operations of method 1600 may be performed by one or more wireless access devices, such as the wireless access device 1212 of FIG. 12.

In this example, the method begins with operation 1605, where location data is sensed by a wireless access device. For example, the wireless access device may include a GPS transceiver that is configured to sense longitude and latitude of the wireless access device. In other examples, operation 1605 may comprise determining location data based on determining a connection to an optical network terminal and determining a location of the optical network terminal.

Flow proceeds to operation 1610, where location data is provided to a provider network. For example, the wireless access device may transmit the location data to a wireless access control server at the provider network. As discussed, this may be performed as part of a startup procedure when the wireless access device is first turned on and/or connected to a provider network (e.g., through a NID). In other examples, the location data may be provided to a computing module or system on the wireless access device itself. That is, the wireless access device may be configured to self-regulate even without being instructed to do so by the provider network. For example, the wireless access device may store coordinates for restricted geographic areas and generate its own configuration data based on whether the sensed location data is within a restricted area. For example, the wireless access device may be periodically updated by the provider network with any changes to coordinates for restricted geographic areas, but otherwise the method 1600 may be performed without interaction with the provider network, in some examples.

Flow proceeds to operation 1615, where configuration information is received that is based on the location data. As discussed, in some examples, the wireless access control server may use the location data from the wireless access device to determine whether the wireless access device is located within a restricted geographic area. The configuration information may be based on that determination and include instructions of whether (and how) to disable certain wireless channels of the wireless access device to avoid using prohibited bandwidths in the wireless access device's current location. As discussed, this operation 1615 may also be performed by the wireless access device itself.

Flow proceeds to operation 1620, where the configuration information is applied to automatically disable at least one wireless channel of the wireless access device. For example, if indicated by the configuration information received at operation 1615, the wireless access device may disable one or more channels that the hardware and software configurations of the wireless access device might otherwise permit. In examples, such disabling may occur programmatically and without user intervention.

Flow proceeds to operation 1625, where updated location data is sensed. In examples, operation 1625 may comprise similar operations to operation 1605 and may sense updated location information for the wireless access device after such device is reconnected in a different location, upon restarting of the device, or otherwise.

At operation 1630, the updated location data may be provided. For example, operation 1630 may include similar operations as operation 1610, but based on the sensed updated location data.

Flow proceeds to operation 1635, where updated configuration information is received. As discussed, the updated configuration information may be different from the initial configuration information depending on whether the updated location is (or is not) within an area with a similar set of restrictions as the initial location.

Flow proceeds to operation 1640, where the updated configuration information is applied. As discussed, the application of the updated configuration information may result in the automatic re-enablement of a previously disabled channel and/or in the disabling of one or more additional channels.

FIG. 17 depicts internal components of an example of NID 1208. In the example depicted in FIG. 17, the NID 1208 may accommodate the receipt and transmission of optical signals according to multiple standards in a single customer premises device. For example, the NID 1208 may be configured to receive and transmit both gigabyte passive optical network (GPON) signals and 10-gigabyte-capable symmetric passive optical network (XGS-PON) signals in a single device. This permits the network service provider, among other things, to deliver one NID 1208 to any customer premises, whether or not the particular customer premises is currently being served by an OLT providing GPON service or XGS-PON service. As a network is upgraded (e.g., from GPON service to XGS-PON service), the network service provider can connect the customer premises to an OLT providing the upgraded service (e.g., XGS-PON) and then programmatically alter the NID 1208 to transceive signals according to the upgraded standard without requiring a new NID 1208 to be delivered or installed at the customer premises.

In the depicted, nonexclusive example of FIG. 17, the NID 1208 may be connectable to fiber optic cable 1218 (see FIG. 12) via an optical splitting apparatus (OSA) 1702. In a downstream direction, OSA 1702 may include circuitry to receive an optical signal from the provider network 1216 via fiber optic cable 1218, and divide the signal based on its wavelength before forwarding the divided signals to different laser drivers (e.g., first laser driver 1704 and second laser driver 1706). In an upstream direction, OSA 1702 may also be configured to receive signals from different laser drivers (e.g., first laser driver 1704 and second laser driver 1706) at different wavelengths and output a combined signal on fiber optic cable 1218.

First laser driver 1704 may receive downstream signals optical signals within a first wavelength band from OSA 1702, while second laser driver 1706 may receive optical signals within a second wavelength band (different from the first wavelength band) from the OSA 1702. For downstream data transfer (from the provider network through OSA 1702), the first laser driver 1704 and second laser driver 1706 may include circuitry to convert the optical signals to electrical signals to be outputted to the receiving multiplexer 1708. In examples, the first laser driver 1704 and second laser driver 1706 may include one or more high-speed photo diodes or transistors to receive the optical signal and output a radio-frequency (RF) electrical signal output.

For upstream data transfer, the first laser driver 1704 may be configured to convert an electrical signal received from the transmitting demultiplexer 1708 and convert the electrical signal to an optical signal within the first wavelength band. Such signal is then transmitted to the OSA 1702 and then to the provider network on optical cable 1218. Similarly, for upstream data transfer, the second laser driver 1706 may be configured to convert an electrical signal received from the transmitting demultiplexer 1708 and convert the electrical signal to an optical signal within the second wavelength band. Such signal is also then transmitted to the OSA 1702 and then to the provider network on optical cable 1218. Both of the first laser driver 1704 and second laser driver 1706 may include laser diodes to emit light at a specific wavelength. The electrical signal is used to modulate the intensity of the laser light, which in turn encodes the data onto the optical signal.

In examples, the first and second wavelength bands are specific to particular PON protocols, such as GPON or XGS-PON. For example, GPON employs a downstream wavelength of 1480-1500 nm and an upstream wavelength of 1290-1330 nm, while XGS-PON employs a downstream wavelength of 1575-1580 nm and an upstream wavelength of 1260-1280 nm. In examples, the OSA 1702 may split out downstream signals within the wavelength band associated with GPON and transmit those to the first laser driver 1704, while sending signals within the wavelength band associated with XGS-PON to second laser driver 1706. In an upstream data transfer, the laser driver that is specific to a particular PON protocol that is currently being employed may be chosen (e.g., by sending a signal to the transmitting demultiplexer 1710 to output the electrical signal received from processing circuit 1712 to the correct laser driver 1704, 1706 for that PON protocol).

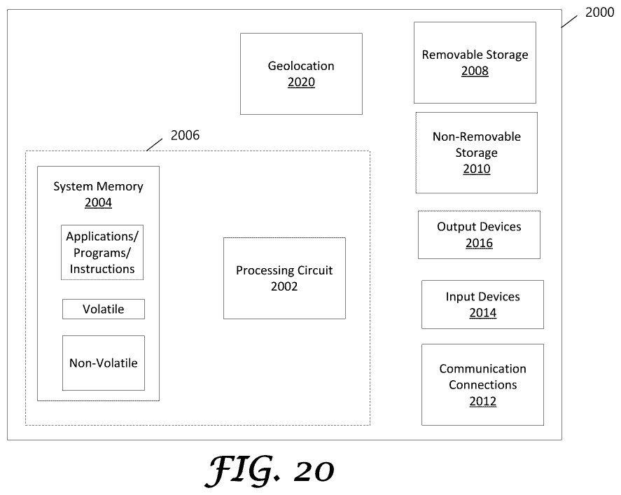

Processing circuit 1712 may comprise one or more computing devices, such as a system-on-a-chip, comprising at least one processor and associated memory, storage, and communications ports and connectors. For example, processing circuit 1712 may comprise some or all of the operating environment described with respect to FIG. 20.

In examples, processing circuit 1712 may be powered by power system 1714, which may comprise one or more power cables, transformers, or other power-management circuitry to permit the processing circuit 1712 and the NID 1208 to receive and utilize sufficient power to function.

Processing circuit 1712 may also be operatively connected to a first user port 1716 and a second user port 1718. In examples, user ports 1716 and 1718 are Ethernet ports that permit the NID to be connected by a wired connection to one or more client devices and/or wireless access devices, such as wireless access device 1212 (e.g., a router). In some examples, the first and second user ports 1716 and 1718 may be identical. In other examples, the first user port 1716 may comprise a standard Ethernet port that permits data transmission speeds of up to one gigabit, while the second user port 1718 may comprise a 10-gigabit Ethernet port (including, e.g., a 10 G physical layer (PHY) to permit the increased speed). For example, if a user previously using GPON service was switched to an XGS-PON service and subscribed to a data plan allowing up to 10 G speed, the Ethernet cable connecting the user device (e.g., wireless access device 1212 or computing device 1214) may need to be switched from the first user port 1716 to the second user port 1718; however, the NID 1208 would not need to be replaced, as discussed herein.

As discussed, the processing circuit 1712 may include (or be operatively connected) to one or more storage systems, such as secure flash memory 1720, non-volatile memory 1722, and random-access memory 1724. In some examples, the user of secure flash memory 1720 may enable a one-time authentication process to be performed and before the secure flash memory disables itself (to prevent later customer authentication). In examples, the non-volatile memory 1722 may store application code, operating system(s), and instructions to permit the processing circuit 1712 to perform certain routing and other functions, and the RAM 1724 may provide operating memory for the processing circuit 1712 to temporarily store data, among other things. The processing circuit may also be operatively connected to a debugging port 1726 (to allow a technician to hard-wire connect for debugging purposes), a reset button 1730 (to allow a hardware reset of the processing circuit), and status light emitting diodes 1730 (to signal the current status of one or more functions of the NID 1218 to a user).

In examples, the processing circuit 1712 may comprise multiple operating systems and/or application program modules to allow it to operate receiving, processing, and routing data according to multiple PON protocols, such as GPON and XGS-PON. For example, the first and second PON protocols may differ in how data is encoded (e.g., differences in header syntax, frame rate, frame processing, etc. As such, in some examples, the processing circuit may operate in a particular PON mode based on a signal received from the provider network. For example, the processing circuit 1712 may receive a signal (e.g., a packet) addressed to the NID 1218. As such, rather than routing the packet through one of the user ports 1716, 1718 to the wireless access device 1212, the packet may include an indication that the processing circuit should operate in a first mode (e.g., according to a first PON protocol) or a second mode (e.g., according to a second PON protocol). If more than two PON protocols are supported by the NID, then additional modes are possible and contemplated. For example, a third laser driver could be added that is specific to the wavelength range of a third PON protocol, among other possibilities.

The indication of the mode in which to operate may, in examples, cause the processing circuit 1712 to take several actions. First, the processing circuit may switch between operating system(s) and/or application program(s) that are specific to the PON protocol corresponding to the selected mode. That is, if the difference in PON protocol requires different upstream and/or downstream processing by the processing circuit 1712 than it was then providing, it will switch to the appropriate operating system and/or application(s) necessary for the new PON protocol.

Further, the processing circuit will instruct the receiving multiplexer 1708 and transmitting multiplexer 1710 which path to turn on. For example, if the NID 1208 was previously operating in the first PON protocol (e.g., GPON), but the processing circuit 1712 receives an indication from the provider network (e.g., via optical cable 1218) that it should switch to the second PON protocol (e.g., XGS-PON), then the processing circuit will signal the receiving multiplexer to switch to transmitting the downstream signal received from the second laser driver 1706 to the processing circuitry 1712. Similarly, the processing circuit will (in this example) cause the transmitting demultiplexer 1710 to stop transmitting the upstream electrical signal received from the processing circuit 1712 to the first laser driver 1704 and start transmitting the upstream electrical signal received from the processing circuit 1712 to the second laser driver 1706.

In this manner, a network provider that switches (e.g., in an end office or edge computing location) the connection of optical cable 1218 from an OLT operating according to the first PON protocol to an OLT operating according to the second PON protocol need only send a signal for the NID 1208 to switch modes. No replacement of the NID 1208, which means that the customer may enjoy the upgraded service immediately and without being required to perform or schedule any equipment replacement.

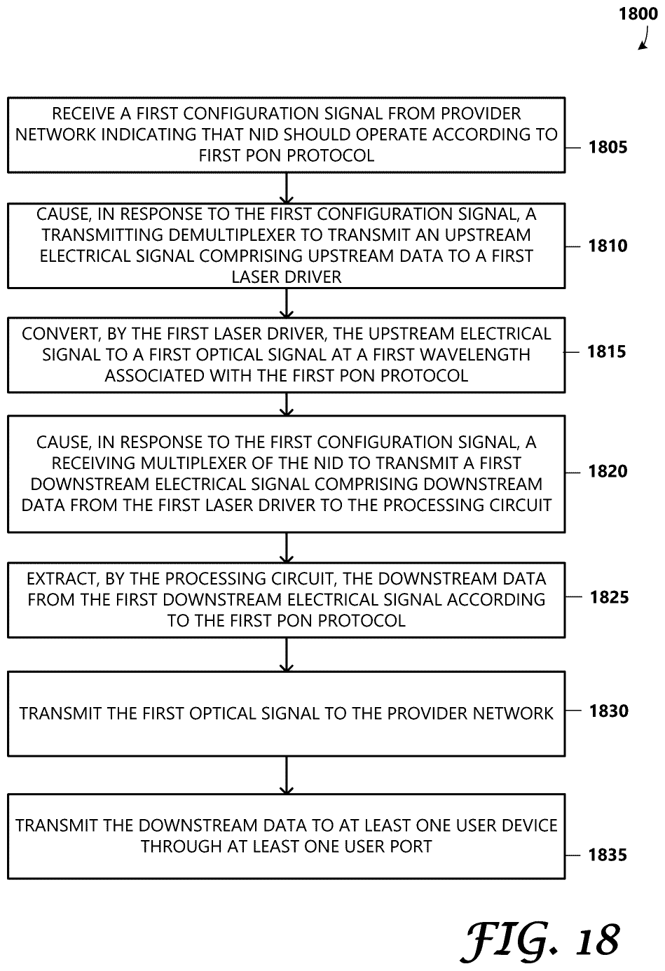

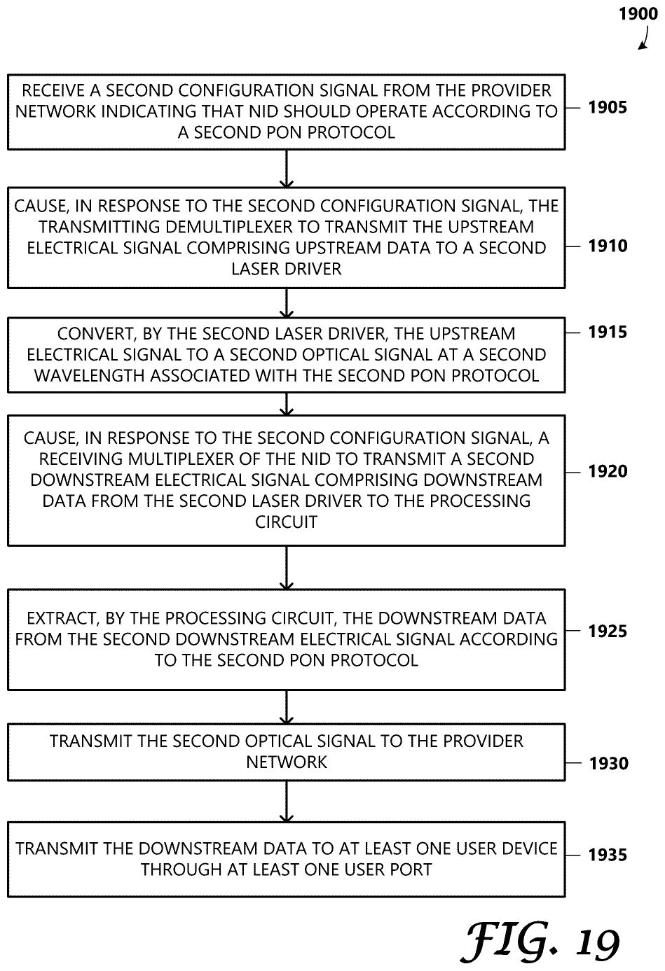

FIG. 18 depicts an example method 1800 according to aspects of the present application. In examples, one or more of the operations of method 1800 are performed by a network interface device, such as NID 1208. In the depicted example, at operation 1805, a first configuration signal is received from a provider network indicating that the NID should operate according to a first PON protocol. For example, an OLT, such as OLT 1205, may send a first configuration signal to the NID 1208 via optical cable 1218. The first configuration signal may include a code or instruction that is interpreted by the NID 1208 (e.g., according to an agreed upon protocol) as an instruction to operate the NID 1208 in a first mode (e.g., according to a first PON protocol, such as GPON). In some examples, the first configuration signal may comprise a downstream optical signal. In some examples, the absence of an instruction or signal to operate in a second mode (e.g., according to a second PON protocol, such as XGS-PON) may be considered a first configuration signal that the NID should operate according to the first PON protocol. For example, the NID 1208 may be programmed to operate according to first PON protocol as a default setting.

Flow proceeds to operation 1810, wherein a first transmitting demultiplexer may be caused, in response to the first configuration signal, to transmit an upstream electrical signal comprising upstream data to a first laser driver. For example, the processing circuit 1712 may instruct transmitting demultiplexer 1710 to send the upstream electrical signal from the processing circuit 1712 (e.g., which was received via one of the user ports 1716, 1718) to the first laser driver 1704 rather than the second laser driver 1706.

Flow proceeds to operation 1815, where the first laser driver converts the upstream electrical signal to a first optical signal at a first wavelength associated with the first PON protocol. For example, when operating in the first mode, the NID 1208 is configured to send upstream data according to the first PON protocol. As such, the first laser driver is tuned to encode the data from the upstream electrical signal onto an optical signal at a wavelength within the designated wavelength range for the first PON protocol (e.g., 1290-1330 nm for a GPON implementation).

Also in response to the first configuration signal, at operation 1820, a receiving muliplexer is caused to transmit a downstream electrical signal comprising downstream data from the first laser driver to the processing circuit. As discussed, when OSA 1702 receives a downstream optical signal within a wavelength range associated with the first GPON protocol, the OSA transmits that downstream optical signal to the first laser driver 1704, which converts the downstream optical signal to a first downstream electrical signal. The first laser driver transmits the first downstream electrical signal to the receiving multiplexer 1708. When operating in the first mode, the processing circuit 1712 may signal the receiving multiplexer to forward the downstream electrical signal being received from the first laser driver 1704 rather than the second laser driver 1706.

At operation 1825, the processing circuit may extract downstream data from the first downstream electrical signal according to the first PON protocol. In examples, the NID 1208 may receive downstream data for all NIDs that are connected to the upstream OLT. In examples, the first PON protocol may define virtual ports that are assigned (according to the first PON protocol) to the NID 1218. The processing circuit may extract downstream data associated with the virtual ports assigned to it.

At operation 1830, the first optical signal is forwarded to the provider network. For example, the first optical signal from the first laser driver 1704 is transmitted by the OSA 1702 via the optical cable 1218 to the provider network (e.g., through the OLT). and forward such downstream data to one or more of the user port(s) 1716, 1718. Further, at operation 1835, the downstream data extracted by the processing circuit may be transmitted through at least one user port. For example, the processing circuit 1712 may transmit the downstream data via one or more of the user ports 1716, 1718 to a user computing device 1214 or wireless access device 1212.

FIG. 19 depicts another example method 1900 according to aspects of the present application. In examples, some or all of the operations of method 1900 may be performed by a network interface device, such as NID 1208. Further, the operations of method 1900 may occur following the operations of method 1800.

At operation 1905, a second configuration signal is received from the provider network indicating that the NID should operate according to a second PON protocol. For example, a NID 1208 that was previously operating according to a first PON protocol (e.g., GPON) may receive a signal from the upstream OLT 1205 indicating that the NID 1208 should now operate according to the XGS-PON protocol. This may occur, in examples, when an XGS-PON protocol service becomes available at the OLT 1205.

Flow proceeds to operation 1910, where the transmitting demultiplexer is caused, in response to the second configuration signal, to transmit the upstream electrical signal to the second laser driver 1706 rather than the first laser driver 1704. As discussed, the second laser driver may be tuned to operate at a wavelength associated with the second PON protocol, such as XGS-PON. As such, the processing circuit 1712, in response to receiving the second configuration signal, may signal the transmitting demultiplexer to begin sending the upstream electrical signal to the second laser driver 1706.

Flow proceeds to operation 1915, where the second laser driver converts the upstream electrical signal to a second optical signal at a second wavelength associated with the second PON protocol. For example, as discussed, the upstream wavelength associated with the second PON protocol may be different from the upstream wavelength associated with the first PON protocol, and the second laser driver may be tuned to convert an electrical signal to a wavelength appropriate for the second PON protocol.

Flow proceeds to operation 1920, where, also in response to the second configuration signal, the receiving multiplexer is caused to transmit a second downstream signal comprising downstream data from the second laser driver to the processing circuit. For example, as discussed, when operating in the second mode (using the second PON protocol), the downstream optical signal will be directed from the OSA 1702 to the second laser driver 1706, which will convert the downstream optical signal to a second downstream electrical signal, which is then transmitted to the receiving multiplexer 1708. The receiving multiplexer may receive a signal from the processing circuit to start transmitting the second downstream electrical signal from the second laser driver to the processing circuit, rather than the first downstream electrical signal from the first laser driver.

Flow proceeds to operation 1925, where the processing circuit extracts the downstream data from the second downstream electrical signal according to the second PON protocol. For example, the second PON protocol may define different virtual ports that are assigned to the NID 1208 than the first PON protocol. The processing circuit 1712 may extract the downstream data associated with the virtual ports assigned according to the second PON protocol, among other processing of the downstream data.

Flow proceeds to operation 1930, where the second optical signal is transmitted to the provider network. For example, the second optical signal of upstream data produced by the second laser driver may be transmitted via the OSA 1702 to the provider network via optical cable 1218.

Further, at operation 1935, the downstream data may be transmitted via at least one user port to at least one user device. For example, the processing circuit 1712 may transmit the downstream data to user computing device 1214, wireless access device 1212, or another device via one or more user ports 1716, 1718.

FIG. 20 depicts an example of a suitable operating environment 2000 that may be used to implement any of the network interface device 108, 1208, wireless access device 112, 1212, edge site(s) 1217, or other computing devices within the systems discussed herein. In its most basic configuration, operating environment 2000 typically includes at least one processing circuit 2002 and memory 2004. The processing circuit may be a processor, which is hardware. Depending on the exact configuration and type of computing device, memory 2004 (storing instructions to perform the methods disclosed herein) may be volatile (such as RAM), non-volatile (such as ROM, flash memory, etc.), or some combination of the two. This most basic configuration is illustrated in FIG. 20 by dashed line 2006. The memory 2004 stores instructions that, when executed by the processing circuit(s) 2002, perform the processes and operations described herein. Further, environment 2000 may also include storage devices (removable 2008, or non-removable 2010) including, but not limited to, solid-state, magnetic disks, optical disks, or tape. Similarly, environment 2000 may also have input device(s) 2014 such as keyboard, mouse, pen, voice input, etc., or output device(s) 2016 such as a display, speakers, printer, etc. Additional communication connections 2012 may also be included that allow for further communication with LAN, WAN, point-to-point, etc. Operating environment 2000 may also include geolocation devices 2020, such as a global positioning system (GPS) device.

Operating environment 2000 typically includes at least some form of computer readable media. Computer readable media can be any available media that can be accessed by processing circuit 2002 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media is non-transitory and does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of any of the above should also be included within the scope of computer readable media.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 20 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the operating environment 2000 on the single integrated circuit (chip). The disclosure may also be practiced using other technologies capable of performing logical operations such as, for example, AND, OR, and NOT, including but not limited to mechanical, optical, fluidic, and quantum technologies.

As used herein, the word “or” is inclusive, so that, for example, “A or B” means any one of (i) A, (ii) B, and (iii) A and B. The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

The description and illustration of one or more aspects provided in this disclosure are not intended to limit or restrict the scope of the disclosure as claimed in any way. The aspects, examples, and details provided in this disclosure are considered sufficient to convey possession and enable others to make and use the best mode of claimed disclosure. The claimed disclosure should not be construed as being limited to any aspect, example, or detail provided in this disclosure. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A network interface device, comprising:
a first laser driver;
a second laser driver;
an optical splitting apparatus operatively connected to the first laser driver and the second laser driver and configured to transmit a first incoming optical signal of a first wavelength to the first laser driver and transmit a second incoming optical signal of a second wavelength to the second laser driver;
a receiving multiplexer, operatively connected to the first laser driver and the second laser driver and configured to transmit either a first electrical signal received from the first laser driver or a second electrical signal received from the second laser driver;
a processing circuit, comprising at least one processor and memory storing instructions that, when executed by the at least one processor, cause the processing circuit to:
receive a configuration signal from a provider network indicating that the network interface device should operate according to a first passive-optical-network (PON) protocol;
provide a first control signal to the receiving multiplexer based on the configuration signal to cause the receiving multiplexer to transmit the first electrical signal to the processing circuit; and
extract, from the first electrical signal and based on the first PON protocol, downstream data; and
at least one user port, operatively connected to the at least one processing circuit, configured to transmit the downstream data to a user device.

2. The network interface device of claim 1, wherein:
the first laser driver is configured to convert the first optical signal to the first electrical signal and the second laser driver is configured to convert the second optical signal to the second electrical signal.

3. The network interface device of claim 1, wherein extracting the downstream data comprises determining a first virtual port number for the network interface device according to the first PON protocol and extracting packets from the first electrical signal that include the first virtual port number.

4. The network interface device of claim 1, wherein:
the instructions, when executed by the at least one processor, further cause the processing circuit to:
receive a second configuration signal from the provider network indicating that the network interface device should operate according to a second PON protocol that is different from the first PON protocol; and
send a second control signal to the receiving multiplexer based on the second configuration signal to cause the receiving multiplexer to transmit the second electrical signal to the processing circuit.

5. The network interface device of claim 4, wherein:
the instructions, when executed by the at least one processor, further cause the processing circuit to extract, from the second electrical signal and based on the second PON protocol, downstream data.

6. The network interface device of claim 5, wherein extracting the downstream data from the second electrical signal further comprises determining a second virtual port number for the network interface device according to the second PON protocol and extracting packets from the first electrical signal that include the second virtual port number.

7. The network interface device of claim 5, wherein the first PON protocol is a gigabite PON (GPON) protocol and the second PON protocol is a ten-gigabyte symmetric PON (XGS-PON) protocol.

8. The network interface device of claim 1, wherein the at least one user port comprises a first user port and a second user port, operatively connected to the at least one processing circuit and configured with a physical (PHY) layer that is adapted for a higher speed Ethernet transmission than the first user port.

9. The network interface device of claim 1, further comprising a housing containing all of: the first laser driver; the second laser driver; the optical splitting apparatus; the receiving multiplexer; the processing circuit; and the at least one user port.

10. A network interface device, comprising:
at least one user port configured to transmit upstream data received from a user device;
a processing circuit, operatively connected to the at least one user port and comprising at least one processor and memory storing instructions that, when executed by the at least one processor, cause the processing circuit to:
receive a configuration signal from a provider network indicating whether the network interface device should operate according to a first passive-optical-network (PON) protocol or a second PON protocol;
generate, from the upstream data and based on the first PON protocol or the second PON protocol, a first electrical signal; and
provide a control signal to a transmitting multiplexer based on the configuration signal to cause the transmitting multiplexer to transmit the first electrical signal to a first laser driver or a second laser driver based on the first control signal;
the transmitting multiplexer, operatively connected to the processing circuit, the first laser driver, and the second laser driver;
the first laser driver, operatively connected to the transmitting multiplexer, and configured to generate a first outgoing optical signal at a first wavelength based on the first electrical signal;
the second laser driver, operatively connected to the transmitting multiplexer, and configured to generate a second outgoing optical signal at a second wavelength based on the first electrical signal; and
an optical splitting apparatus, operatively connected to the first laser driver and the second laser driver and configured to transmit the first outgoing optical signal at the first wavelength or the second outgoing optical signal at the second wavelength to an optical line terminal of the provider network.

11. The network interface device of claim 10, wherein:
the instructions, when executed by the at least one processor, further cause the processing circuit to:
determine that the configuration signal from a provider network indicates that the network interface device should operate according to the first passive-optical-network (PON) protocol;
wherein the generating comprises generating, from the upstream data and based on the first PON protocol, the first electrical signal; and
wherein providing the control signal comprises providing a first control signal to the transmitting multiplexer based on the configuration signal to cause the transmitting multiplexer to transmit the first electrical signal to the first laser driver.

12. The network interface device of claim 11, wherein:
the instructions, when executed by the at least one processor, further cause the processing circuit to:
receive a second configuration signal from the provider network indicating that the network interface device should operate according to the second PON protocol; and
send a second control signal to the transmitting multiplexer based on the second configuration signal to cause the transmitting multiplexer to transmit the first electrical signal to the second laser driver.

13. The network interface device of claim 10, wherein the first PON protocol is a gigabite PON (GPON) protocol and the second PON protocol is a ten-gigabyte symmetric PON (XGS-PON) protocol.

14. The network interface device of claim 10, wherein the at least one user port comprises a first user port and a second user port, operatively connected to the at least one processing circuit and configured with a physical (PHY) layer that is adapted for a higher speed Ethernet transmission than the first user port.

15. The network interface device of claim 10, further comprising a housing containing all of: the first laser driver; the second laser driver; the optical splitting apparatus; the transmitting multiplexer; the processing circuit; and the at least one user port.

16. The network interface device of claim 10, wherein the network interface device comprises an optical network terminal.

17. A method, comprising:
receiving, by a network interface device (NID), a first configuration signal from a provider network indicating that the NID should operate according to a first passive-optical-network (PON) protocol;
causing, in response to the first configuration signal, a transmitting demultiplexer of the NID to transmit an upstream electrical signal comprising upstream data from a processing circuit of the NID to a first laser driver of the NID;
converting, by the first laser driver of the NID, the upstream electrical signal to a first optical signal at a first wavelength associated with the first PON protocol; and
transmitting the first optical signal to the provider network.

18. The method of claim 17, further comprising:
receiving, by the NID, a second configuration signal from the provider network indicating that the NID should operate according to a second PON protocol;
causing, in response to the second configuration signal, the transmitting demultiplexer to transmit the upstream electrical signal comprising upstream data from the processing circuit to a second laser driver of the NID;
converting, by the second laser driver of the NID, the upstream electrical signal to a second optical signal at a second wavelength associated with the second PON protocol, wherein the second wavelength is different from the first wavelength; and
transmitting the second optical signal to the provider network.

19. The method of claim 18, further comprising:
causing, in response to the first configuration signal, a receiving multiplexer of the NID to transmit a first downstream electrical signal comprising downstream data from the first laser driver to the processing circuit; and
extracting, by the processing circuit, the downstream data from the first downstream electrical signal according to the first PON protocol.

20. The method of claim 19, further comprising:
causing, in response to the second configuration signal, the receiving multiplexer to transmit a second downstream electrical signal comprising downstream data from the second laser driver to the processing circuit; and
extracting, by the processing circuit, the downstream data from the second downstream electrical signal according to the second PON protocol.
